(19) United States
(12) Patent Application Publication
(10) Pub. No.: US 2016/0306209 A1
(43) Pub. Date: Oct. 20, 2016

(54) DISPLAY DEVICE

(71) Applicant: SAMSUNG DISPLAY CO., LTD., Yongin-si (KR)

(72) Inventors: Hyoung Sub LEE, Yongin-si (KR); Joo Young YOON, Suwon-si (KR)

(21) Appl. No.: 14/871,838

(22) Filed: Sep. 30, 2015

(30) Foreign Application Priority Data
Apr. 16, 2015 (KR) 10-2015-0053841

(51) Int. Cl. G02F 1/1339; G02F 1/1341; G02F 1/1333; G02F 1/1368

(52) U.S. Cl. CPC G02F 1/13394; G02F 1/1368; G02F 1/1341; G02F 1/133377; G02F 2001/13396

(57) ABSTRACT

A display device for improving a blockage of an injection hole is divided into a center part and an outer part enclosing the center part. The display device includes: a substrate; a thin film transistor positioned on the substrate; a pixel electrode connected to the thin film transistor; a roof layer formed on the pixel electrode and spaced apart from the pixel electrode with a plurality of microcavities; a first injection hole positioned at a first edge of each microcavity; a second injection hole positioned at a second edge facing the first edge of each microcavity; a liquid crystal layer filling the plurality of microcavities; and an encapsulation layer formed on the roof layer and sealing the plurality of microcavities An effective width of the first injection hole is same as an effective width of the second injection hole in the center part, and the effective width of the first injection hole is different from the effective width of the second injection hole in the outer part.

### CROSS-REFERENCE TO RELATED APPLICATION

This application claims priority to and the benefit of Korean Patent Application No. 10-2015-0053841 filed in the Korean Intellectual Property Office on Apr. 16, 2015, the disclosure of which is incorporated herein by reference in its entirety.

### BACKGROUND

(a) Technical Field

The present disclosure relates to a display device, more particularly, to a display device for improving clogging of an injection hole.

(b) Description of the Related Art

A liquid crystal display is one of the widely used flat panel displays nowadays. The liquid crystal display includes two display panels on which field generating electrodes such as a pixel electrode and a common electrode are formed, and a liquid crystal layer is interposed between the field generating electrodes. The liquid crystal display generates an electric field in the liquid crystal layer by applying a voltage to the field generating electrodes, and displays an image by controlling directions of liquid crystal molecules of the liquid crystal layer and polarization of incident light through the liquid crystal layer.

The two display panels forming the liquid crystal display may include a thin film transistor (TFT) array panel and an opposing display panel. In the thin film transistor array panel, a gate line transmitting a gate signal and a data line transmitting a data signal are formed to be crossed, and a thin film transistor connected to the gate line and the data line and a pixel electrode connected to the thin film transistor may be formed. The opposing display panel may include a light blocking member, a color filter, a common electrode, etc. If necessary, the light blocking member, the color filter, and the common electrode may be formed in the thin film transistor array panel.

However, the liquid crystal display essentially uses two substrates, and forms respective constituent elements on the two substrates, therefore the display device is heavy and thick, resulting in high manufacturing costs and long periods of process time.

The information disclosed above in the background section is only for enhancement of understanding of the background information of the present disclosure, therefore it may contain information that does not form a prior art that is already known to a person of ordinary skill in the art.

### SUMMARY

The present disclosure provides a display device and a manufacturing method thereof. The display device has a reduced weight, thickness, cost, and processing time by manufacturing the display device using one substrate.

Further, the display device prevents an alignment layer from blocking an injection hole in an outer part of the display device such that a region where liquid crystal molecules are not injected is generated when manufacturing the display device having one substrate.

The display device is divided into a center part and an outer part enclosing the center part. The display device includes: a substrate; a thin film transistor positioned on the substrate; a pixel electrode connected to the thin film transistor; a roof layer formed on the pixel electrode and spaced apart from the pixel electrode with a plurality of microcavities; a first injection hole positioned at a first edge of each microcavity of the plurality of microcavities and having a first height; a second injection hole positioned at a second edge facing the first edge of each microcavity of the plurality of microcavities and having a second height; a liquid crystal layer filling the plurality of microcavities; and an encapsulation layer formed on the roof layer and sealing the plurality of microcavities. An effective width of the first injection hole is same as an effective width of the second injection hole in the center part, and the effective width of the first injection hole is different from the effective width of the second injection hole in the outer part.

The display device, according to an exemplary embodiment of the present disclosure, may further include: a first supporting member adjacent to the first injection hole and formed at each microcavity of the plurality of microcavities with a column shape; and a second supporting member adjacent to the second injection hole and formed at each microcavity of the plurality of microcavities with the column shape. The first supporting member has a first size and a first number, and the second supporting member has a second size and a second number.

The first size of the first supporting member may be smaller than the second size of the second supporting member in the outer part, and the effective width of the first injection hole may be larger than the effective width of the second injection hole in the outer part.

The first number of the first supporting members may be same as the second number of the second supporting members in the outer part.

The first size and the first number of the first supporting members may be same as the second size and the second number of the second supporting members in the center part.

The first height of the first injection hole may be higher than the second height of the second injection hole.

The first number of the first supporting members may be smaller than the second number of the second supporting members in the outer part, and the effective width of the first injection holes may be larger than the effective width of the second injection holes in the outer part.

The first size of the first supporting members may be same as the second size of the second supporting members in the outer part.

The first size and the first number of the first supporting members may be same as the second size and the second number of the second supporting members.

The first height of the first injection hole may be higher than the second height of the second injection hole.

The first supporting member and the second supporting member may be formed in each microcavity of the plurality of microcavities of the center part, and the second supporting member may be formed in each microcavity of the plurality of microcavities in the outer part.

The first supporting member may not be formed in each microcavity of the plurality of microcavities in the outer part.

The first size and the first number of the first supporting members may be same as the second size and the second number of the second supporting members in the center part.

The first height of the first injection hole may be higher than the second height of the second injection hole.

The display device, according to an exemplary embodiment of the present disclosure, has following effects.

The display device uses one substrate, thereby reducing a weight, a thickness, a cost, and a process time to manufacture the display device.

The size and the number of the supporting members positioned at both injection holes in the outer part are asymmetrical, thereby improving blockage of the injection holes.

### BRIEF DESCRIPTION OF THE DRAWINGS

FIG. 1 is a top plan view showing a region of a display device, according to an exemplary embodiment of the present disclosure.

FIG. 2 is a top plan view showing a center part of a display device, according to an exemplary embodiment of the present disclosure.

FIG. 3 is an equivalent circuit diagram of one pixel of a display device, according to an exemplary embodiment of the present disclosure.

FIG. 4 is a top plan view of one pixel of a center part of a display device, according to an exemplary embodiment of the present disclosure.

FIG. 5 is a cross-sectional view of a display device, according to an exemplary embodiment of the present disclosure taken along a line V-V of FIG. 4.

FIG. 6 is a cross-sectional view of a display device, according to an exemplary embodiment of the present disclosure taken along a line VI-VI of FIG. 4.

FIG. 7 is a top plan view of an outer part of a display device, according to an exemplary embodiment of the present disclosure.

FIG. 8 is a top plan view of one pixel of a display device, according to an exemplary embodiment of the present disclosure.

FIG. 9 (a) is a top plan view of one microcavity of a center part of a display device, according to an exemplary embodiment of the present disclosure.

FIG. 9 (b) is a top plan view of one microcavity positioned at an outer part of a display device, according to a reference example.

FIG. 9 (c) is a top plan view of one microcavity positioned at an outer part of a display device, according to an exemplary embodiment of the present disclosure.

FIG. 10 is a top plan view of one microcavity positioned at an outer part of a display device, according to an exemplary embodiment of the present disclosure.

FIG. 11 is a top plan view of one microcavity positioned at an outer part of a display device, according to an exemplary embodiment of the present disclosure.

### DETAILED DESCRIPTION OF THE EMBODIMENTS

The present disclosure will be described more fully hereinafter with reference to the accompanying drawings, in which exemplary embodiments of the present disclosure are shown. As those skilled in the art would realize, the described embodiments may be modified in various different ways, without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element or one or more intervening elements may also be present. In contrast, when an element is referred to as being “directly on” another element, there may be no intervening elements present.

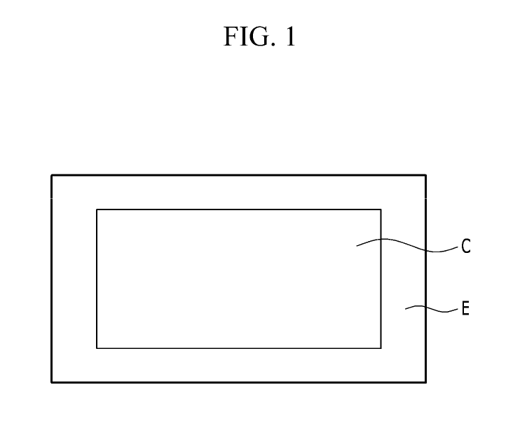

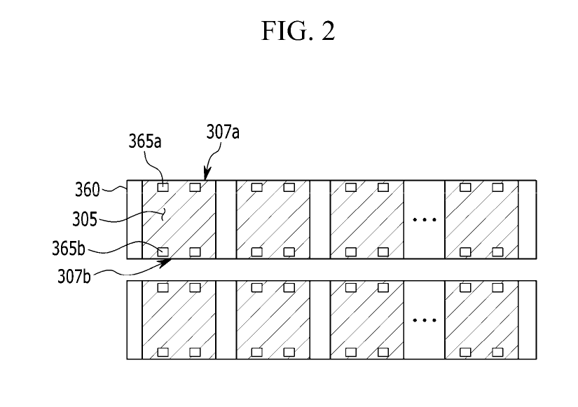

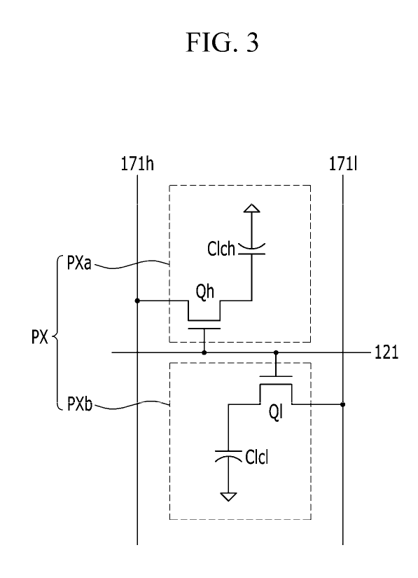

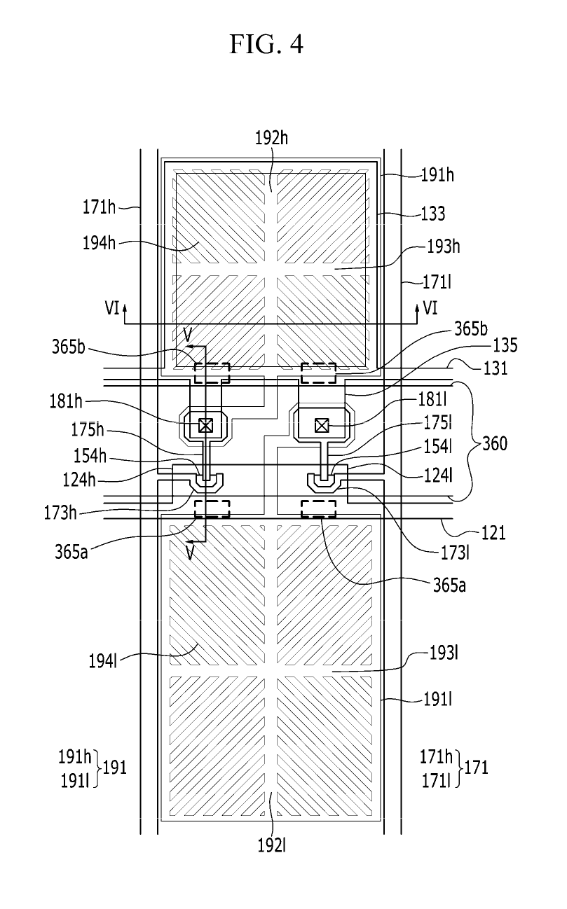

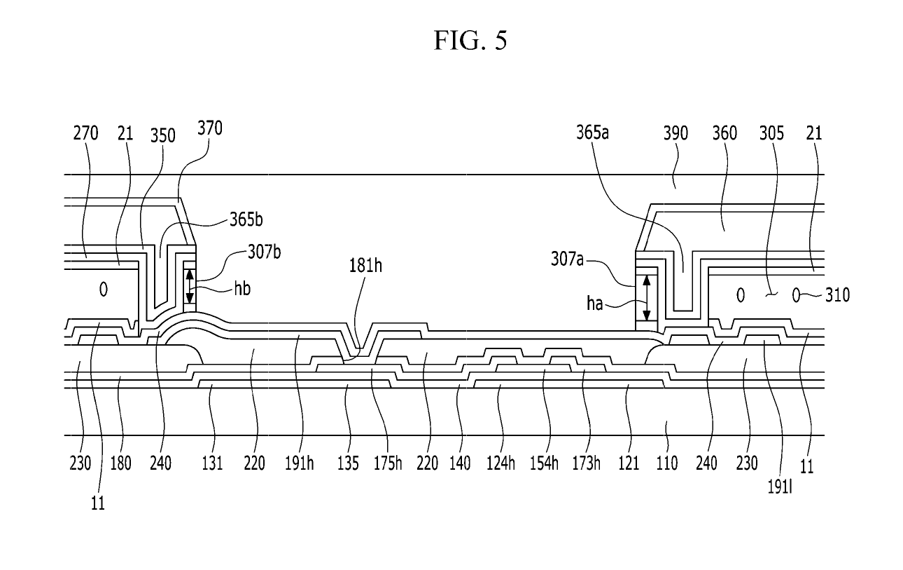

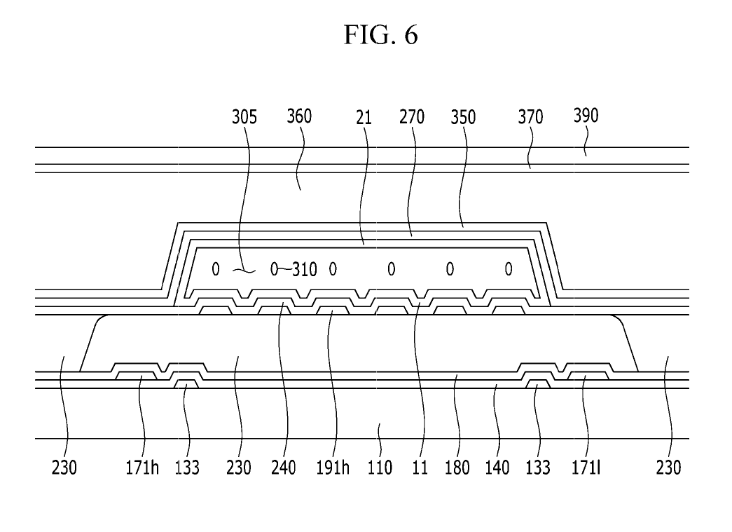

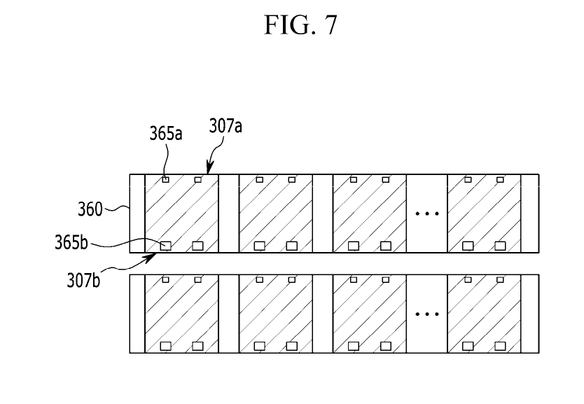

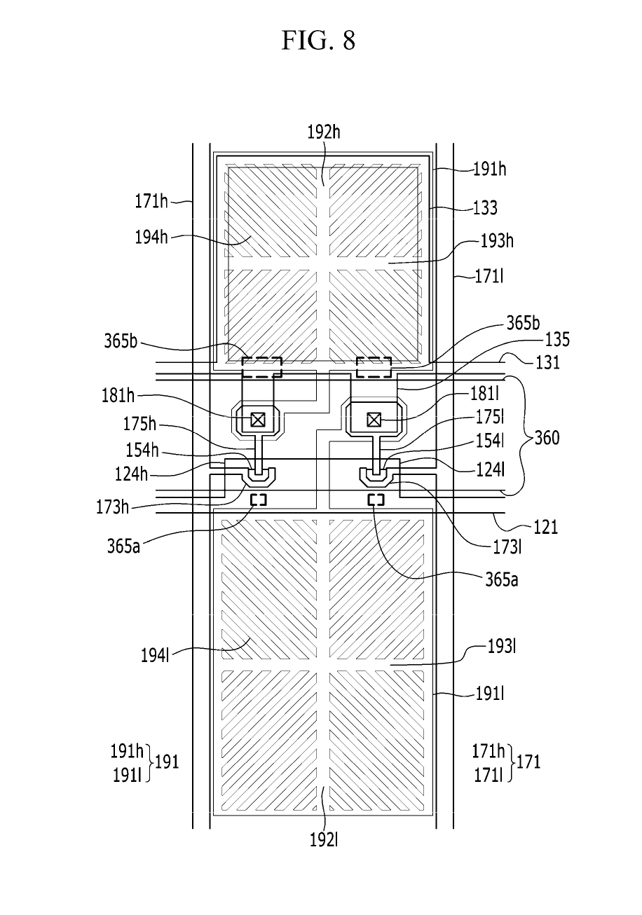

Firstly, a display device, according to an exemplary embodiment of the present disclosure, will be described with reference to FIG. 1 to FIG. 8. FIG. 1 is a top plan view showing a region of a display device, according to an exemplary embodiment of the present disclosure, FIG. 2 is a top plan view showing a center part of a display device, according to an exemplary embodiment of the present disclosure, and FIG. 3 is an equivalent circuit diagram of one pixel of a display device, according to an exemplary embodiment of the present disclosure. FIG. 4 is a top plan view of one pixel of a center part of a display device, according to an exemplary embodiment of the present disclosure, FIG. 5 is a cross-sectional view of a display device taken along a line V-V of FIG. 4, and FIG. 6 is a cross-sectional view of a display device taken along a line VI-VI of FIG. 4. FIG. 7 is a top plan view of an outer part of a display device, according to an exemplary embodiment of the present disclosure, and FIG. 8 is a top plan view of one pixel of a display device, according to an exemplary embodiment of the present disclosure.

Referring to FIG. 1, a display device, according to an exemplary embodiment of the present disclosure, is divided into at least two regions. The display device includes a center part C and an outer part E. The outer part E includes an outer edge enclosing the center part C. The center part C and the outer part E have similar structures, but have differences in some configurations. The structure of the center part C and the outer part E of the display device, according to an exemplary embodiment of the present disclosure, will be described in detail.

First, the center part C of the display device will be described with reference to FIG. 2 to FIG. 6. Referring to FIG. 2, in the center part of a display device, according to an exemplary embodiment of the present disclosure, a plurality of microcavities 305 are formed. The roof layer 360 extends in the row direction and covers the microcavities 305 that are formed under the roof layer 360.

The microcavities 305 may be disposed in a matrix shape, and the roof layer 360 may not be formed between the plurality of microcavities 305 adjacent in a column direction. That is, the roof layer 360 covers the upper surface and a partial side surface of the microcavities 305, but does not cover the remaining partial side surface. Portions where the microcavities 305 are not covered by the roof layer 360 are referred to as injection holes.

The injection holes may be formed in both side edges of the microcavities 305. The injection holes include a first injection hole 307a and a second injection hole 307b. The first injection hole 307a is formed to expose the side of a first edge of the microcavity 305, and the second injection hole 307b is formed to expose the side of a second edge of the microcavity 305. The side of the first edge and the side of the second edge of the microcavity 305 face each other. The roof layer 360 covers the side of the remaining edge except for the first edge and the second edge of the microcavity 305.

In addition, supporting members are formed in the respective edges of the microcavity 305. The supporting members include a first supporting member 365a and a second supporting member 365b. The first supporting member 365a is formed to be adjacent to the first edge of the microcavity 305, and the second supporting member 365b is formed to be adjacent to the second edge of the microcavity 305. That is, the first supporting member 365a is formed to be adjacent to the first injection hole 307a, and the second supporting member 365b is formed to be adjacent to the second injection hole 307b.

The first supporting member 365a and the second supporting member 365b are formed under the roof layer 360, thereby preventing the roof layer 360 from sagging downwardly near the first injection hole 307a and the second injection hole 307b. That is, the first supporting member 365a and the second supporting member 365b have a function of supporting the roof layer 360.

In one microcavity 305, the first supporting member 365a and the second supporting member 365b are formed in symmetry. The size of the first supporting member 365a is the same as the size of the second supporting member 365b. A number of first supporting members 365a is the same as a number of second supporting members 365b. For example, two first supporting members 365a may be formed at the first edge of the microcavity 305, and two second supporting member 365b may be formed at the second edge of the microcavity 305.

Referring to FIG. 3, a display device, according to the exemplary embodiment of the present disclosure, includes a plurality of signal lines and a pixel PX connected to the signal lines. Although not illustrated in the drawings, a plurality of pixels PX may be disposed in a matrix form including a plurality of pixel rows and a plurality of pixel columns.

Each pixel PX may include a first sub-pixel PXa and a second sub-pixel PXb. The first sub-pixel PXa and the second sub-pixel PXb may be vertically disposed. The signal lines include a gate line 121 transferring a gate signal, and a first data line 171h and a second data line 171l transferring different data voltages.

A first switching element Qh connected to the gate line 121 and the first data line 171h is formed, and a second switching element Ql connected to the gate line 121 and the second data line 171l is formed. A first liquid crystal capacitor Clch connected to the first switching element Qh is formed in the first sub-pixel PXa, and a second liquid crystal capacitor Clcl connected to the second switching element Ql is formed in the second sub-pixel PXb. A first terminal of the first switching element Qh is connected to the gate line 121, a second terminal of the first switching element Qh is connected to the first data line 171h, and a third terminal of the first switching element Qh is connected to the first liquid crystal capacitor Clch. A first terminal of the second switching element Ql is connected to the gate line 121, a second terminal of the second switching element Ql is connected to the second data line 171l, and a third terminal of the second switching element Ql is connected to the second liquid crystal capacitor Clcl.

Referring to an operation of the display device, according to an exemplary embodiment of the present disclosure, if a gate-on voltage is applied to the gate line 121, the first switching element Qh and the second switching element Ql connected to the gate line 121 are turned on, and the first and second liquid crystal capacitors Clch and Clcl are charged by the different data voltages transferred through the first and second data lines 171h and 171l. According to one embodiment, the data voltage transferred by the second data line 171l is lower than the data voltage transferred by the first data line 171h. Accordingly, the second liquid crystal capacitor Clcl may be charged by a voltage that is lower than that of the first liquid crystal capacitor Clch to improve lateral visibility.

However, the present disclosure is not limited to the embodiments described above, and the layout design of thin film transistors for applying different voltages to the two subpixels PXa and PXb can be modified in various ways without deviating from the scope of the present disclosure. For example, a pixel PX may include a single pixel or more than two subpixels.

Referring to FIG. 4 to FIG. 6, a structure of one pixel of the center part C of the display device, according to an exemplary embodiment of the present disclosure, will be described. A gate line 121, and a first gate electrode 124h and a second gate electrode 124l protruding from the gate line 121, are formed on a substrate 110. The gate line 121 extends in a first direction, and transfers a gate signal. The gate line 121 is positioned between the two microcavities 305 adjacent in a column direction. That is, the gate line 121 is positioned in a first valley V1. The first gate electrode 124h and the second gate electrode 124l protrude to an upper side of the gate line 121 in the top plan view if FIG. 4. The first gate electrode 124h and the second gate electrode 124l may be connected to each other to form a single protrusion portion. However, the present disclosure is not limited thereto, and protrusion shapes of the first gate electrode 124h and the second gate electrode 124l can be variously modified without deviating from the scope of the present disclosure.

A storage electrode line 131 and storage electrodes 133 and 135 protruding from the storage electrode line 131 may be further formed on the substrate 110. The storage electrode line 131 extends in a direction that is parallel with the gate line 121, and is formed to be spaced apart from the gate line 121. A predetermined voltage may be applied to the storage electrode line 131. The storage electrode 133 protruding over the storage electrode line 131 is formed to surround the edge of the first sub-pixel PXa. The storage electrode 135 protruding down the storage electrode line 131 is formed to be adjacent to the first gate electrode 124h and the second gate electrode 124l.

A gate insulating layer 140 is formed on the gate line 121, the first gate electrode 124h, the second gate electrode 124l, the storage electrode line 131, and the storage electrodes 133 and 135. The gate insulating layer 140 may be made of an inorganic insulating material such as a silicon nitride (SiNx) and a silicon oxide (SiOx). The gate insulating layer 140 may be formed to be a single layer or a multilayer.

A first semiconductor 154h and a second semiconductor 154l are formed on the gate insulating layer 140. The first semiconductor 154h may be positioned on the first gate electrode 124h, and the second semiconductor 154l may be positioned on the second gate electrode 124l. The first semiconductor 154h may be formed beneath the first data line 171h, and the second semiconductor 154l may be formed beneath the second data line 171l. The first semiconductor 154h and the second semiconductor 154l may be made of amorphous silicon, polycrystalline silicon, a metal oxide, or the like.

Ohmic contact members (not illustrated) may be further formed on the first semiconductor 154h and the second semiconductor 154l, respectively. The ohmic contact members may be made of a material such as a silicide or n+ hydrogenated amorphous silicon to which an n-type impurity is doped at a high concentration.

The first data line 171h, the second data line 171l, a first source electrode 173h, a first drain electrode 175h, a second source electrode 173l, and a second drain electrode 175l are formed on the first semiconductor 154h, the second semiconductor 154l, and the gate insulating layer 140. The first data line 171h and the second data line 171l transfer the data signal, and extend in a second direction to cross the gate line 121 and the storage electrode line 131. The data line 171 is positioned between the two microcavities 305 adjacent in a row direction. That is, the data line 171 is positioned in a second valley V2. The first data line 171h and the second data line 171l transfer the different data voltages. For example, the data voltage transferred by the second data line 171l is lower than the data voltage transferred by the first data line 171h.

The first source electrode 173h is formed to protrude from the first data line 171h over the first gate electrode 124h, and the second source electrode 173l is formed to protrude from the second data line 171l over the second gate electrode 124l. Each of the first drain electrode 175h and the second drain electrode 175l includes a wide end portion and a rod-shaped end portion. The wide end portions of the first drain electrode 175h and the second drain electrode 175l overlap with the storage electrode 135 that protrudes down the storage electrode line 131. The rod-shaped end portions of the first drain electrode 175h and the second drain electrode 175l are partially surrounded by the first source electrode 173h and the second source electrode 173l, respectively.

The first and second gate electrodes 124h and 124l, the first and second source electrodes 173h and 173l, and the first and second drain electrodes 175h and 175l form first and second thin film transistors (TFT) Qh and Ql together with the first and second semiconductors 154h and 154l, respectively. A channel of the thin film transistor is formed in each of the semiconductors 154h and 154l between each of the source electrodes 173h and 173l and each of the drain electrodes 175h and 175l, respectively.

A passivation layer 180 is formed on the first data line 171h, the second data line 171l, the first source electrode 173h, the first drain electrode 175h, the first semiconductor 154h exposed between the first source electrode 173h and the first drain electrode 175h, the second source electrode 173l, the second drain electrode 175l, and the second semiconductor 154l exposed between the second source electrode 173l and the second drain electrode 175l. The passivation layer 180 may be made of an organic insulating material or an inorganic insulating material, and formed as a single layer or a multilayer.

A color filter 230 is formed in each pixel PX on the passivation layer 180. Each color filter 230 may display any one of primary colors such as three primary colors of red, green, and blue. The color filter 230 is not limited to the three primary colors of red, green, and blue, and may display other colors such as cyan, magenta, yellow, and white-based colors. The color filter 230 may not be formed in the first valley V1 and/or the second valley V2.

A light blocking member 220 is formed in a region between the adjacent color filters 230. The light blocking member 220 is formed on a boundary of the pixel PX and the thin film transistors Qh and Ql to prevent light leakage. The color filter 230 and the light blocking member 220 may overlap with each other in a partial region. Also, the color filter 230 may overlap to each other between two pixels PX adjacent in the row direction to prevent light leakage. The passivation layer 180 and the light blocking member 220 have a first contact hole 181h exposing the wide end of the first drain electrode 175h and a second contact hole 181l exposing the wide end of the second drain electrode 175l.

A pixel electrode 191 is formed on the light blocking member 220. The pixel electrode 191 may be made of a transparent metal oxide such as indium-tin oxide (ITO) and indium-zinc oxide (IZO). The pixel electrode 191 includes a first sub-pixel electrode 191h and a second sub-pixel electrode 191l that are separated from each other while the gate line 121 and the storage electrode line 131 are interposed between the first sub-pixel electrode 191h and the second sub-pixel electrode 191l. The first sub-pixel electrode 191h and the second sub-pixel electrode 191l are disposed on and beneath the pixel PX based on the gate line 121 and the storage electrode line 131. The first subpixel electrode 191h is positioned in the first subpixel PXa, and the second subpixel electrode 191l is positioned in the second subpixel PXb.

The first subpixel electrode 191h is connected with the first drain electrode 175h through the first contact hole 181h, and the second subpixel electrode 191l is connected to the second drain electrode 175l through the second contact hole 181l. Accordingly, when the first thin film transistor Qh and the second thin film transistor Ql are turned on, the first subpixel electrode 191h and the second subpixel electrode 191l receive different data voltages from the first drain electrode 175h and the second drain electrode 175l, respectively.

An overall shape of each of the first subpixel electrode 191h and the second subpixel electrode 191l is a quadrangle. The first subpixel electrode 191h and the second subpixel electrode 191l include cross stems including horizontal stems 193h and 193l and vertical stems 192h and 192l crossing the horizontal stems 193h and 193l, respectively. Further, each of the first subpixel electrode 191h and the second subpixel electrode 191l includes a plurality of minute branches 194h and 194l.

The pixel electrode 191 is divided into four subregions by the horizontal stems 193h and 193l and the vertical stems 192h and 192l. The minute branches 194h and 194l obliquely extend from the horizontal stems 193h and 193l and the vertical stems 192h and 192l, and the extending direction may form an angle of approximately 45 degrees or 135 degrees with the gate line 121 or the horizontal stems 193h and 193l. Further, extending directions of the minute branches 194h and 194l of the two adjacent subregions may be perpendicular to each other. In some exemplary embodiments, the first subpixel electrode 191h and the second subpixel electrode 191l may further include outer stems surrounding outsides of the first subpixel PXa and the second subpixel PXb.

The layout of the pixel, the structure of the thin film transistor, and the shape of the pixel electrode described above are exemplified, and the present disclosure is not limited to the exemplary embodiments, and may be variously modified without deviating from the scope of the present disclosure.

A first insulating layer 240 is formed on the pixel electrode 191. The first insulating layer 240 may be made of an inorganic insulating material such as a silicon nitride (SiNx) or a silicon oxide (SiOx). A common electrode 270 is formed to be separated from the pixel electrode 191 by a predetermined distance on the first insulating layer 240. The microcavity 305 is formed between the pixel electrode 191 and the common electrode 270. That is, the microcavity 305 is enclosed by the pixel electrode 191 and the common electrode 270. The common electrode 270 is formed in the row direction. The common electrode 270 is formed to cover the upper surface and the side of the microcavity 305, and is formed in the region between the microcavities 305 adjacent in the row direction. The size of the microcavity 305 may be variously changed according to the size and the resolution of the display device. According to another embodiment, the common electrode 270 may be formed between the pixel electrode 191 and the insulating layer. In this case, the microcavity 305 is positioned on the common electrode 270.

The common electrode 270 may be made of a transparent metal oxide such as indium-tin oxide (ITO) and indium-zinc oxide (IZO). The common electrode 270 may be applied with a predetermined voltage, and the electric field may be formed between the pixel electrode 191 and the common electrode 270.

Alignment layers 11 and 21 are formed on the pixel electrode 191 and below the common electrode 270. The alignment layers 11 and 21 include a first alignment layer 11 and a second alignment layer 21. The first alignment layer 11 and the second alignment layer 21 may be formed as vertical alignment layers, and be made of an alignment material such as polyamic acid, polysiloxane, and polyimide. The first and second alignment layers 11 and 21 may be connected at the side wall of the edge of the microcavity 305. The first alignment layer 11 is formed on the pixel electrode 191. The second alignment layer 21 is formed below the common electrode 270 to face the first alignment layer 11.

A liquid crystal layer including liquid crystal molecules 310 is formed in the microcavity 305 positioned between the pixel electrode 191 and the common electrode 270. The liquid crystal molecules 310 have negative dielectric anisotropy, and may stand up in a vertical direction with respect to the substrate 110 when no electric field is applied. That is, a vertical alignment may be performed.

When data voltages are applied, the first sub-pixel electrode 191h and the second sub-pixel electrode 191l generate an electric field together with the common electrode 270 changes a direction of the liquid crystal molecules 310 contained in the microcavity 305 between the two electrodes 191 and 270. Luminance of light passing through the liquid crystal layer is changed based on the direction of the liquid crystal molecules 310.

The common electrode 270 may be formed on a second insulating layer 350. The second insulating layer 350 may be made of an inorganic insulating material such as a silicon nitride (SiNx) or a silicon oxide (SiOx), if necessary.

The roof layer 360 is formed on the second insulating layer 350. The roof layer 360 may be made of an organic material. The roof layer 360 is formed in the row direction to cover the microcavities 305 disposed in the row direction. The roof layer 360 is formed to cover the upper surface of the side of the microcavity 305. The roof layer 360 may be hardened by a curing process to maintain a shape of the microcavity 305.

The common electrode 270 and the roof layer 360 are formed to cover the side of the partial edge of the microcavity 305 and not to cover the side of the other partial edge. In this case, the portion where the microcavity 305 is not covered by the common electrode 270 and the roof layer 360 is referred to as the injection holes. The injection holes include the first injection holes 307a and the second injection hole 307b. The first injection hole 307a exposes the side of the first edge of the microcavity 305, and the second injection hole 307b exposes the side of the second edge of the microcavity 305. For example, in the top plan view, the first edge may be an upper edge of the microcavity 305, and the second edge may be a lower edge of the microcavity 305. In the manufacturing process of the display device, the microcavity 305 is exposed by the injection holes 307a and 307b such that an alignment material or a liquid crystal material may be injected into the microcavity 305 through the injection holes 307a and 307b.

The supporting members 365a and 365b are formed in the microcavity 305. The supporting members 365a and 365b are positioned at both edges of the microcavity 305. The supporting members 365a and 365b include the first supporting member 365a and the second supporting member 365b. The first supporting member 365a is formed to be adjacent to the first edge of the microcavity 305, and the second supporting member 365b is formed to be adjacent to the second edge of the microcavity 305.

The supporting members 365a and 365b extend from the roof layer 360 and may be made of the same material as the roof layer 360. The supporting members 365a and 365b are formed to be protruded downwardly from the roof layer 360. The supporting members 365a and 365b are formed in a column shape and support the roof layer 360, thereby preventing the roof layer 360 from sagging downwardly.

According to one embodiment, the first supporting member 365a and the second supporting member 365b have the same size. The number of the first supporting members 365a is equal to the number of the second supporting members 365b.

The height of the microcavity 305 is uniform in the most of the region, but is decreased at the second edge. The pixel electrode 191 and the common electrode 270 are disposed at both sides via the microcavity 305. To uniformly form an electric field between the two electrodes 191 and 270, it is preferable that the height of the microcavity 305 is uniform. However, the height of the microcavity 305 at the first edge is higher than the height of the microcavity 305 in the second edge. That is, the height ha of the microcavity 305 is higher than the height hb of the microcavity 305. By differentiating the heights of the injection holes 307a and 307b, the magnitudes of capillary forces of the injection holes 307a and 307b may be differentiated.

According to one embodiment, the height ha of the first injection hole 307a is higher than the height hb of the second injection hole 307b such that the capillary force of the first injection hole 307a is lower than the capillary force of the second injection hole 307b. Accordingly, when injecting the alignment material through the injection holes 307a and 307b, the alignment layer is agglomerated near the second injection hole 307b. The second injection hole 307b may be blocked by the agglomeration of the alignment layer and the first injection hole 307a may be perforated so that the liquid crystal molecules may be injected through the first injection hole 307a. After the injection process of the liquid crystal molecules, in the process removing the remaining liquid crystal molecules, in the present exemplary embodiment, the supporting members 365a and 365b formed at both injection holes 307a and 307b may prevent the liquid crystal molecules 310 inside the microcavity 305 from being discharged.

A third insulating layer 370 may be formed on the roof layer 360. The third insulating layer 370 may be made of an inorganic insulating material such as a silicon nitride (SiNx) or a silicon oxide (SiOx). The third insulating layer 370 may be formed to cover the upper surface and/or the side of the roof layer 360. The third insulating layer 370 has a function of protecting the roof layer 360 made of an organic material and may be omitted if necessary.

An encapsulation layer 390 is formed on the third insulating layer 370. The encapsulation layer 390 is formed to cover the injection holes 307a and 307b exposing the portion of the microcavity 305 to the outside. That is, the encapsulation layer 390 may seal the microcavity 305 to prevent the liquid crystal molecules 310 formed within the microcavity 305 from leaking out. The encapsulation layer 390 contacts the liquid crystal molecules 310 and thus may be made of a material that does not react with the liquid crystal molecules 310. For example, the encapsulation layer 390 may be made of parylene or the like.

The encapsulation layer 390 may be a multilayer such as a double layer and a triple layer. The double layer includes two layers that are made of different materials. The triple layer includes three layers, and materials of mutually adjacent layers differ from each other. For example, the encapsulation layer 390 may include a layer made of an organic insulating material and a layer made of an inorganic insulating material.

Although not illustrated, a polarizer may be further formed on upper and lower surfaces of the display device. The polarizer may be made of a first polarizer and a second polarizer. The first polarizer may be attached on the lower surface of the substrate 110, and the second polarizer may be attached on the encapsulation layer 390.

Next, the outer part E of the display device, according to an exemplary embodiment of the present disclosure, will be described with reference to FIG. 7 and FIG. 8. The structure of the outer part E of the display device is similar to the structure of the center part C, therefore the overlapping description is omitted and differences will be mainly described. One of the main differences of the outer part E and the center part C is symmetry of the first supporting member and the second supporting member, and this will be described in detail.

Referring to FIG. 7 and FIG. 8, the outer part of the display device is similar to the structure of the center part to the extent that the plurality of microcavities 305 are covered by the roof layer 360. The partial edge of the microcavity 305 is not covered by the roof layer 360, and this is referred to as the injection holes. The injection holes include the first injection hole 307a exposing the side of the first edge of the microcavity 305 and the second injection hole 307b exposing the side of the second edge of the microcavity 305.

The supporting members 365a and 365b are formed at both edges of the microcavity 305. The supporting members includes the first supporting member 365a and the second supporting member 365b. The first supporting member 365a is formed to be adjacent to the first edge of the microcavity 305, and the second supporting member 365b is formed to be adjacent to the second edge of the microcavity 305.

The first supporting member 365a and the second supporting member 365b of the microcavity 350 are asymmetrical. The size of the first supporting member 365a is different from the size of the second supporting member 365b. The size of the first supporting member 365a may be smaller than the size of the second supporting member 365b. The number of first supporting members 365a may be the same as the number of second supporting members 365b. For example, two first supporting members 365a may be formed at the first edge of the microcavity 305, and two second supporting members 365b may be formed at the second edge of the microcavity 305.

In the outer part of the display device, according to an exemplary embodiment of the present disclosure, the height of the microcavity 305 is uniform in the most of the region including the center part, however it is decreased at the second edge. Accordingly, the height ha of the first injection hole 307a is higher than the height hb of the second injection hole 307b, and the capillary force of the first injection hole 307a is lower than the capillary force of the second injection hole 307b. Furthermore, in the outer part of the display device, according to an exemplary embodiment of the present disclosure, the size of the first supporting member 365a is smaller than the size of the second supporting member 365b such that the difference between the capillary force of the first injection hole 307a and the capillary force of the second injection hole 307b is further increased.

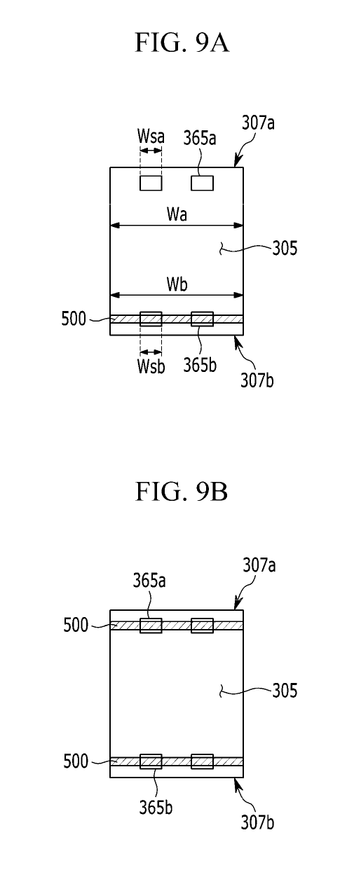

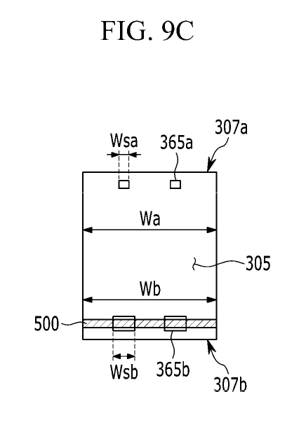

Next, a bunching position of the alignment layer in the center part and the outer part of the display device, according to an exemplary embodiment of the present disclosure, will be described with reference to FIG. 9. FIG. 9 (a) is a top plan view of one microcavity of a center part of a display device, according to an exemplary embodiment of the present disclosure, FIG. 9 (b) is a top plan view of one microcavity positioned at an outer part of a display device, according to a reference example, and FIG. 9 (c) is a top plan view of one microcavity positioned at an outer part of a display device, according to an exemplary embodiment of the present disclosure.

Referring to FIG. 9 (a), as above-described, in the center part of the display device, the size of the first supporting member 365a is the same as the size of the second supporting member 365b. In addition, the number of first supporting members 365a is the same as the number of second supporting members 365b.

The first injection hole 307a may be partially blocked by the first supporting member 365a, and the alignment material or the liquid crystal molecules may be injected through the portion that is not blocked by the first supporting member 365a. In this case, the magnitude of the capillary force in the first injection hole 307a is affected by the effective width of the first injection hole 307a. As shown in Equation 1, the effective width of the first injection hole 307a is a value of which the width occupied by the first supporting member 365a is subtracted from the length from one end to the other end of the first injection hole 307a. As the effective width of the first injection hole 307a enlarges, the capillary force in the first injection hole 307a is decreased.

Ea=Wa−Wsa*m [Equation1]

(Ea: an effective width of the first injection hole, Wa: an entire width of the first injection hole, Wsa: a width of the first supporting member, m: a number of the first supporting member)

The second injection hole 307b may be partially blocked by the second supporting member 365b, and the alignment material or the liquid crystal molecules may be injected through the portion that is not blocked by the second supporting member 365b. In this case, the magnitude of the capillary force in the second injection hole 307b is affected by the effective width of the second injection hole 307b. As shown in Equation 2, the effective width of the second injection hole 307b is value of which the width occupied by the second supporting member 365b is subtracted from the length from one end to the other end of the second injection hole 307b. As the effective width of the second injection hole 307b enlarges, the capillary force in the second injection hole 307b is decreased.

Eb=Wb−Wsb*n [Equation 2]

(Eb: an effective width of the second injection hole, Wb: an entire width of the second injection hole, Wsb: a width of the second supporting member, n: a number of the second supporting member)

In the center part of the display device, according to an exemplary embodiment of the present disclosure, the size and the number of the first supporting members 365a are the same as the size and the number of the second supporting members 365b such that the effective width of the first injection hole 307a is the same as the effective width of the second injection hole 307b. Accordingly, the same effective width of the injection holes 307a and 307b does not cause a difference of the capillary force. However, the difference of the heights of the first injection hole 307a and the second injection hole 307b (the first injection hole 307a being higher than the height of the second injection hole 307b) causes the difference of the capillary force. Accordingly, the capillary force is relatively large in the second injection hole 307b, and an aggregation region 500 of the alignment layer is generated near the second injection hole 307b.

Referring to FIG. 9 (b), in the outer part of the display device, according to a reference example, the size of the first supporting member 365a is the same as the size of the second supporting member 365b. In addition, the number of the first supporting members 365a is the same as the number of the second supporting members 365b.

In this way, when the outer part of the display device has the same structure as the center part, the aggregation region 500 of the alignment layer is generated near the first injection hole 307a and the second injection hole 307b by a coffee stain effect (or a coffee ring effect).

The coffee stain effect refers to a phenomenon that a stain is darker at an edge than at an inner side if coffee spilled on a table dries. When the coffee is spilled on the table, if the coffee is firstly dried at the edge, the coffee spilled at the center moves to the edge. As the coffee on the edge is dried, more coffee spilled at the center and still wet moves to the edge. When this phenomenon is repeated, and the coffee is finally dried, the stain becomes relatively darker at the edge.

Like the coffee, in the case of the alignment layer, the alignment layer positioned at the outer part of the display device is firstly dried, and the remaining alignment layer on the center part moves to the outer part. Accordingly, the aggregation region of the alignment layer generated at the outer part is larger than the center part of the display device.

Referring to FIG. 9 (c), in the display device, the size of the first supporting member 365a is smaller than the size of the second supporting member 365b at the outer part. Also, the number of the first supporting members 365a is the same as the number of the second supporting members 365b.

In the outer part of the display device, according to an exemplary embodiment of the present disclosure, the size of the first supporting member 365a is smaller than the size of the second supporting member 365b such that the effective width of the first injection hole 307a is larger than the effective width of the second injection hole 307b. Accordingly, the capillary force of the second injection hole 307b is larger than the capillary force of the first injection hole 307a. Furthermore, since the height of the first injection hole 307a is higher than the height of the second injection hole 307b, the capillary force of the second injection hole 307b is further larger than the capillary force of the first injection hole 307a. Accordingly, the difference of the capillary forces of the first injection hole 307a and the second injection hole 307b in the center part of the display device is larger than the difference of the capillary forces of the first injection hole 307a and the second injection hole 307b in the outer part. Accordingly, in the reference example of FIG. 9 (b), the aggregation region 500 of the alignment layer is generated near the first injection hole 307a and the second injection hole 307b, however in the present exemplary embodiment of FIG. 9 (c), the aggregation region 500 of the alignment layer is generated only near the second injection hole 307b.

In the reference example shown with reference to FIG. 9 (b), both injection holes 307a and 307b may be blocked by the coffee stain effect in the outer part of the display device. In contrast, in the present exemplary embodiment shown with reference to FIG. 9 (c), the supporting members 365a and 365b with the capillary forces of both injection holes 307a and 307b are asymmetrical to increase the difference of both injection holes 307a and 307b, thereby preventing both injection holes 307a and 307b from being blocked.

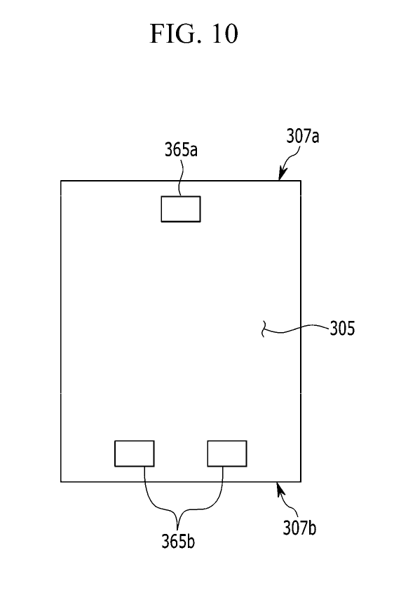

Hereinafter, the display device, according to an exemplary embodiment of the present disclosure, will be described with reference to FIG. 10. The display device shown in FIG. 10 is similar to the display device shown in FIG. 1 to FIG. 9, therefore the overlapping description is omitted and only differences will be described. One of the main differences from the previous exemplary embodiment is that the numbers of the first supporting members and the second supporting members are different at the outer part of the display device, and this will be described in detail.

FIG. 10 is a top plan view showing one microcavity positioned in an outer part of a display device, according to an exemplary embodiment of the present disclosure. The supporting members are formed at both edges of the microcavity 305 positioned at the outer part of the display device. The supporting members include the first supporting member 365a and the second supporting member 365b. The first supporting member 365a is formed to be adjacent to the first edge of the microcavity 305, and the second supporting member 365b is formed to be adjacent to the second edge of the microcavity 305.

The first supporting member 365a and the second supporting member 365b are asymmetrical. The number of the first supporting members 365a is different from the number of the second supporting members 365b. According to one embodiment, the number of the first supporting members 365a may be smaller than the number of the second supporting members 365b. For example, one first supporting member 365a may be formed at the first edge of the microcavity 305, and two second supporting member 365b may be formed at the second edge of the microcavity 305. The size of the first supporting members 365a is the same as the size of the second supporting members 365b.

In the outer part of the display device, the number of the first supporting members 365a is smaller than the number of the second supporting members 365b, therefore the effective width of the first injection hole 307a is larger than the effective width of the second injection hole 307b. Accordingly, the capillary force of the second injection hole 307b is larger than the capillary force of the first injection hole 307a. Furthermore, since the height of the first injection hole 307a is higher than the height of the second injection hole 307b, the capillary force of the second injection hole 307b is further larger than the capillary force of the first injection hole 307a. Accordingly, the difference of the capillary forces of the first injection hole 307a and the second injection hole 307b in the center part of the display device is further larger than the difference of the capillary forces of the first injection hole 307a and the second injection hole 307b in the outer part.

An exemplary case in which the sizes of the first supporting member and the second supporting member are the same and the numbers thereof are different is described, however the present disclosure is not limited to such exemplary case. The sizes and the numbers of the first supporting members and the second supporting members may both be different. For example, the size of the first supporting members may be smaller than the size of the second supporting members, and the number of the first supporting members may be smaller than the number of the second supporting members.

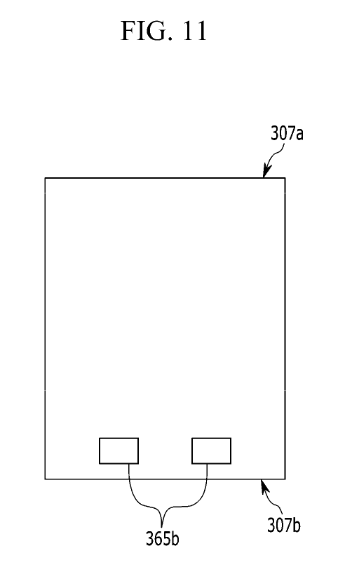

Next, the display device, according to an exemplary embodiment of the present disclosure, will be described with reference to FIG. 11. The display device shown in FIG. 11 is similar to the display device shown in FIG. 1 to FIG. 9, therefore the overlapping description is omitted and only differences will be described. One of the main differences from the previous exemplary embodiment is that the first supporting member is not formed in the outer part of the display device, and this will be described in detail.

FIG. 11 is a top plan view showing one microcavity positioned in an outer part of a display device, according to an exemplary embodiment of the present disclosure. The second supporting member 365b is formed at the second edge of the microcavity 305 positioned in the outer part of the display device. The supporting member is not formed in the first edge of the microcavity 305.

The supporting member is not formed at the first edge in the outer part of the display device, but the second supporting member 365b is only formed at the second edge such that the effective width of the first injection hole 307a is larger than the effective width of the second injection hole 307b. Accordingly, the capillary force of the second injection hole 307b is larger than the capillary force of the first injection hole 307a. Furthermore, since the height of the first injection hole 307a is higher than the height of the second injection hole 307b, the capillary force of the second injection hole 307b is further larger than the capillary force of the first injection hole 307a. Accordingly, the difference of the capillary forces of the first injection hole 307a and the second injection hole 307b in the center part of the display device is further larger than the difference of the capillary forces of the first injection hole 307a and the second injection hole 307b in the outer part.

While the present disclosure has been described in connection with what is presently considered to be practical exemplary embodiments, it is to be understood that the present disclosure is not limited to the disclosed embodiments, but, on the contrary, is intended to cover various modifications and equivalent arrangements without deviating from the spirit and scope of the present disclosure.

<Description of symbols>

| | |
|---|---|
| 121: gate line | 131: storage electrode line |
| 171: data line | 191: pixel electrode |
| 270: common electrode | 305: microcavity |
| 307a: first injection hole | 307b: second injection hole |
| 360: roof layer | 365a: first supporting member |
| 365b: second supporting member | 390: encapsulation layer |

What is claimed is:

1. A display device including a center part and an outer part enclosing the center part, comprising:
a substrate;
a thin film transistor positioned on the substrate;
a pixel electrode connected to the thin film transistor;
a roof layer formed on the pixel electrode and spaced apart from the pixel electrode with a plurality of microcavities;
a first injection hole positioned at a first edge of each microcavity of the plurality of microcavities and having a first height;
a second injection hole positioned at a second edge facing the first edge of each microcavity of the plurality of microcavities and having a second height;
a liquid crystal layer filling the plurality of microcavities; and
an encapsulation layer formed on the roof layer and sealing the plurality of microcavities,
wherein an effective width of the first injection hole is same as an effective width of the second injection hole in the center part, and
wherein the effective width of the first injection hole is different from the effective width of the second injection hole in the outer part.

2. The display device of claim 1, further comprising:
a first supporting member adjacent to the first injection hole and formed at each microcavity of the plurality of microcavities with a column shape; and
a second supporting member adjacent to the second injection hole and formed at each microcavity of the plurality of microcavities with the column shape,
wherein the first supporting member has a first size and a first number, and
wherein the second supporting member has a second size and a second number.

3. The display device of claim 2, wherein
the first size of the first supporting member is smaller than the second size of the second supporting member in the outer part, and
the effective width of the first injection hole is larger than the effective width of the second injection hole in the outer part.

4. The display device of claim 3, wherein
the first number of the first supporting members is same as the second number of the second supporting members in the outer part.

5. The display device of claim 3, wherein
the first size and the first number of the first supporting members are same as the second size and the second number of the second supporting members in the center part.

6. The display device of claim 3, wherein
the first height of the first injection hole is higher than the second height of the second injection hole.

7. The display device of claim 2, wherein
the first number of the first supporting members is smaller than the second number of the second supporting members in the outer part, and
the effective width of the first injection hole is larger than the effective width of the second injection hole in the outer part.

8. The display device of claim 7, wherein
the first size of the first supporting member is same as the second size of the second supporting member in the outer part.

9. The display device of claim 7, wherein
the first size and the first number of the first supporting members are same as the second size and the second number of the second supporting members.

10. The display device of claim 7, wherein
the first height of the first injection hole is higher than the second height of the second injection hole.

11. The display device of claim 2, wherein
the first supporting member and the second supporting member are formed in each microcavity of the plurality of microcavities of the center part, and
the second supporting member is formed in each microcavity of the plurality of microcavities in the outer part.

12. The display device of claim 11, wherein
the first supporting member is not formed in each microcavity of the plurality of microcavities in the outer part.

13. The display device of claim 11, wherein
the first size and the first number of the first supporting members are same as the second size and the second number of the second supporting members in the center part.

14. The display device of claim 11, wherein
the first height of the first injection hole is higher than the second height of the second injection hole.
